(19) United States
(12) Patent Application Publication
(10) Pub. No.: US 2014/0235099 A1
(43) Pub. Date: Aug. 21, 2014

(54) COAXIAL CABLE CONTINUITY CONNECTOR

(71) Applicants: Donald Andrew Burris, Peoria, AZ (US); William Bernard Lutz, Glendale, AZ (US)

(72) Inventors: Donald Andrew Burris, Peoria, AZ (US); William Bernard Lutz, Glendale, AZ (US)

(21) Appl. No.: 13/827,522

(22) Filed: Mar. 14, 2013

Related U.S. Application Data
(60) Provisional application No. 61/770,715, filed on Feb. 28, 2013.
(60) Provisional application No. 61/766,436, filed on Feb. 19, 2013.

(51) Int. Cl. H01R 9/05

(52) U.S. Cl. CPC H01R 9/05
USPC 439/578

(57) ABSTRACT

A coaxial connector for coupling an end of a coaxial cable to an equipment appliance port or terminal is disclosed. The coaxial cable has an inner conductor, a dielectric surrounding the inner conductor, an outer conductor surrounding the dielectric, and a jacket surrounding the outer conductor is disclosed. The coaxial cable connector comprises a body, a coupler rotatably attached to the body, and a post secured to the body. The post has a structural feature. A grounding member is disposed between the post and the coupler in the structural feature. The grounding member establishes an electrical grounding path which may be maintained between coupler and post, including, when the coupler is not tightly fastened to a terminal and without restricting rotation of coupler relative to post.

### RELATED APPLICATIONS

This application claims the benefit of priority under 35 U.S.C. §119 of U.S. Provisional Application Ser. No. 61/770,715 filed on Feb. 28, 2013, the content of which is relied upon and incorporated herein by reference in its entirety.

This application claims the benefit of priority under 35 U.S.C. §119 of U.S. Provisional Application Ser. No. 61/766,436 filed on Feb. 19, 2013, the content of which is relied upon and incorporated herein by reference in its entirety.

This application is related to U.S. application Ser. No. 13/198,765, filed Aug. 5, 2011, entitled “Coaxial Cable Connector with Radio Frequency Interference and Grounding Shield”, which is incorporated herein by reference in its entirety.

This application is related to U.S. application Ser. No. 13/653,095, filed Oct. 16, 2012, entitled “Coaxial Cable Connector with Integral RFI Protection”, which is incorporated herein by reference in its entirety.

This application is related to U.S. application Ser. No. 13/652,969, filed Oct. 16, 2012, entitled “Coaxial Cable Connector With Integral Continuity Contacting Portion”, which is incorporated herein by reference in its entirety.

### BACKGROUND

1. Field of the Disclosure

The disclosure relates generally to coaxial cable connectors, and particularly to a coaxial cable connector having a continuity member.

2. Technical Background

Coaxial cable connectors, such as type F connectors, are used to attach coaxial cable to another object or appliance, e.g., a television set, DVD player, modem or other electronic communication device having a terminal adapted to engage the connector. The terminal of the appliance includes an inner conductor and a surrounding outer conductor.

Coaxial cable includes a center conductor for transmitting a signal. The center conductor is surrounded by a dielectric material, and the dielectric material is surrounded by an outer conductor. The outer conductor may be in the form of a conductive foil and/or braided sheath. The outer conductor is typically maintained at ground potential to shield the signal transmitted by the center conductor from stray noise, and to maintain a continuous, desired impedance over the signal path. The outer conductor is usually surrounded by a plastic cable jacket that electrically insulates, and mechanically protects, the outer conductor. Prior to installing a coaxial connector onto an end of the coaxial cable, the end of the coaxial cable is typically prepared by stripping off the end portion of the jacket to expose the end portion of the outer conductor. Similarly, it is common to strip off a portion of the dielectric to expose the end portion of the center conductor.

Coaxial cable connectors of the type known in the trade as “F connectors” often include a tubular post designed to slide over the dielectric material, and under the outer conductor of the coaxial cable, at the prepared end of the coaxial cable. If the outer conductor of the cable includes a braided sheath, then the exposed braided sheath is usually folded back over the cable jacket. The cable jacket and folded-back outer conductor extend generally around the outside of the tubular post and are typically received in an outer body of the connector. The outer body of the connector is often fixedly secured to the tubular post. A coupler is typically rotatably secured around the tubular post and includes an internally-threaded region for engaging external threads formed on the outer conductor of the appliance terminal. Alternatively or additionally, the coupler may friction fit, screw and/or latch on to the outer conductor of the appliance terminal.

When connecting the end of a coaxial cable to a terminal of a television set, equipment box, modem, computer or other appliance, it is important to achieve a reliable electrical connection between the outer conductor of the coaxial cable and the outer conductor of the appliance terminal. Typically, this goal is usually achieved by ensuring that the coupler of the connector is fully tightened over the connection port of the appliance. When fully tightened, the head of the tubular post of the connector directly engages the edge of the outer conductor of the appliance port, thereby making a direct electrical ground connection between the outer conductor of the appliance port and the tubular post. The tubular post is engaged with the outer conductor of the coaxial cable.

The increased use of self-install kits provided to home owners by some CATV system operators has resulted in customer complaints due to poor picture quality in video systems and/or poor data performance in computer/internet systems. Additionally, CATV system operators have found upstream data problems induced by entrance of unwanted RF signals into their systems. Complaints of this nature result in CATV system operators having to send a technician to address the issue. Often times it is reported by the technician that the cause of the problem is due to a loose F connector fitting, sometimes as a result of inadequate installation of the self-install kit by the homeowner. An improperly installed or loose connector may result in poor signal transfer because there are discontinuities along the electrical path between the devices, resulting in ingress of undesired radio frequency (“RF”) signals where RF energy from an external source or sources may enter the connector/cable arrangement causing a signal to noise ratio problem resulting in an unacceptable picture or data performance. Many of the current state of the art F connectors rely on intimate contact between the F male connector interface and the F female connector interface. If, for some reason, the connector interfaces are allowed to pull apart from each other, such as in the case of a loose F male coupler, an interface “gap” may result. If not otherwise protected this gap can be a point of RF ingress as previously described.

As mentioned above, the coupler is typically rotatably secured about the head of the tubular post. The head of the tubular post usually includes an enlarged shoulder, and the coupler typically includes an inwardly-directed flange for extending over and around the shoulder of the tubular post. In order not to interfere with free rotation of the coupler, manufacturers of such F-style connectors routinely make the outer diameter of the shoulder (at the head of the tubular post) of smaller dimension than the inner diameter of the central bore of the coupler. Likewise, manufacturers routinely make the inner diameter of the inwardly-directed flange of the coupler of larger dimension than the outer diameter of the non-shoulder portion of the tubular post, again to avoid interference with rotation of the coupler relative to the tubular post. In a loose connection system, wherein the coupler of the coaxial connector is not drawn tightly to the appliance port connector, an alternate ground path may fortuitously result from contact between the coupler and the tubular post, particularly if the coupler is not centered over, and axially aligned with, the tubular post. However, this alternate ground path is not stable, and can be disrupted as a result of vibrations, movement of the appliance, movement of the cable, or the like.

Alternatively, there are some cases in which such an alternate ground path is provided by fortuitous contact between the coupler and the outer body of the coaxial connector, provided that the outer body is formed from conductive material. This alternate ground path is similarly unstable, and may be interrupted by relative movement between the appliance and the cable, or by vibrations. Moreover, this alternate ground path does not exist at all if the outer body of the coaxial connector is constructed of non-conductive material. Such unstable ground paths can give rise to intermittent failures that are costly and time-consuming to diagnose.

### SUMMARY OF THE DETAILED DESCRIPTION

One embodiment disclosed herein relates to a coaxial connector for coupling an end of a coaxial cable to an equipment appliance port or terminal. The coaxial cable has an inner conductor, a dielectric surrounding the inner conductor, an outer conductor surrounding the dielectric, and a jacket surrounding the outer conductor. The coaxial cable connector comprises a body, a coupler rotatably attached to the body, and a post secured to the body. The post has a structural feature. A grounding member is disposed between the post and the coupler in the structural feature. The grounding member establishes an electrical grounding path which may be maintained between coupler and post, including, when the coupler is not tightly fastened to an appliance port.

Another embodiment disclosed herein relates to a coaxial cable connector for coupling an end of a coaxial cable to an equipment appliance port or terminal. The coaxial cable has an inner conductor, a dielectric surrounding the inner conductor, an outer conductor surrounding the dielectric, and a jacket surrounding the outer conductor. The connector has a body, a coupler rotatably attached to the body with the coupler having a lip with a forward facing surface, and a post secured to the body. The post has a first end, a head, a neck, and a second end, and a structural feature. A grounding member having an arcuate shape is disposed in and retained by the structural feature between the post and the coupler. The grounding member is resilient and biased toward coupler and establishes an electrical grounding path between the post and the coupler such that the electrical grounding path is maintained between the post and the coupler when the coupler is not tightly fastened to an appliance port. The structural feature may be a groove in the post or formed by a tapered portion and a first radial face of the post.

Additional features and advantages will be set forth in the detailed description which follows, and in part will be readily apparent to those skilled in the art from that description or recognized by practicing the embodiments as described in the detailed description and claims hereof, as well as the appended drawings.

It is to be understood that both the foregoing general description and the following detailed description are merely exemplary, and are intended to provide an overview or framework to understanding the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a cross-sectional view of an exemplary embodiment of a coaxial connector comprising a post, a grounding member and a coupler having a secondary bore with a tapered transition and the post includes a structural feature in the form of a channel;

FIG. 1A is a detail cross-sectional view of a portion of the coaxial connector of FIG. 2 illustrating the post, grounding member and coupler;

FIG. 1B is a detail, perspective view of the continuity member of the coaxial connector of FIG. 1;

FIG. 1C is a detail, plan view of the continuity member of the coaxial connector of FIG. 1;

FIG. 2 is a cross-sectional view of an exemplary embodiment of a coaxial connector comprising a post, a grounding member and a coupler having a uniform bore without a tapered transition and the post includes a structural feature in the form of a channel;

FIG. 2A is a detail, cross-sectional view of a portion of the coaxial connector of FIG. 2 illustrating the post, grounding member and coupler;

FIG. 3 is a cross-sectional view of an exemplary embodiment of a coaxial connector comprising a post, a grounding member and a coupler having a uniform bore without a tapered transition and the post includes a structural feature in the form of a circumferential groove;

FIG. 3A is a detail, cross-sectional view of a portion of the coaxial connector of FIG. 3 illustrating the post, grounding member and coupler;

FIG. 3B is a detail, perspective view of the continuity member of the coaxial connector of FIG. 3;

FIG. 4 is a cross-sectional view of an exemplary embodiment of a coaxial connector comprising a post having a tapered portion between a first radial face and a second radial face, a grounding member and a coupler;

FIG. 4A is a detail, cross-sectional view of a portion of the coaxial connector of FIG. 4 illustrating the post, grounding member and coupler;

FIG. 5 is a cross-sectional view of an exemplary embodiment of a coaxial connector comprising a post, a coupler, and a grounding member having an overlapping structure with a circular cross-section;

FIG. 5A is a detail, cross-sectional view of a portion of the coaxial connector of FIG. 5 illustrating the post, grounding member and coupler;

FIG. 5B is a detail, perspective view of the continuity member of the coaxial connector of FIG. 5;

FIG. 6 is a cross-sectional view of an exemplary embodiment of a coaxial connector comprising a post, a coupler, and a grounding member having an overlapping structure with a flattened cross section and a coupler;

FIG. 6A is a detail, cross-sectional view of a portion of the coaxial connector of FIG. 6 illustrating the post, grounding member and coupler;

FIG. 6B is a perspective view of the continuity member of the coaxial connector of FIG. 6;

FIG. 7 is a cross-sectional view of the exemplary embodiment of coaxial cable connector of FIG. 1 with a cable fully inserted and the connector compressed to capture the cable. The connector of FIG. 1 is illustrated as attached to a terminal.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein. Whenever possible, like reference numbers will be used to refer to like components or parts.

Coaxial cable connectors are used to couple a prepared end of a coaxial cable to a threaded female equipment connection port of an appliance. The coaxial cable provides an electrical and mechanical connection between the conductor of the coaxial connector and the conductor of the female equipment connection terminal port, and establishes a ground path from an outer conductor of the coaxial cable to the terminal or equipment appliance port.

Embodiments disclosed herein include a coaxial connector for coupling an end of a coaxial cable to an equipment appliance port or terminal. The coaxial cable has an inner conductor, a dielectric surrounding the inner conductor, an outer conductor surrounding the dielectric, and a jacket surrounding the outer conductor. The coaxial cable connector comprises a body, a coupler rotatably attached to the body, and a post secured to the body. The post has a structural feature. A grounding member is disposed between the post and the coupler in the structural feature. The grounding member establishes and maintains an electrical grounding path between coupler and post, including, when the coupler is not tightly fastened to a terminal or equipment appliance port.

For purposes of this description, the term “forward” will be used to refer to a direction toward the portion of the coaxial cable connector that attaches to a terminal, including an equipment appliance port. The term “rearward” will be used to refer to a direction that is toward the portion of the coaxial cable connector that receives the coaxial cable. The term “terminal” will be used to refer to any type of connection medium to which the coaxial cable connector may be coupled, as non-limiting examples, an equipment appliance port, any other type of connection port, or an intermediate termination device.

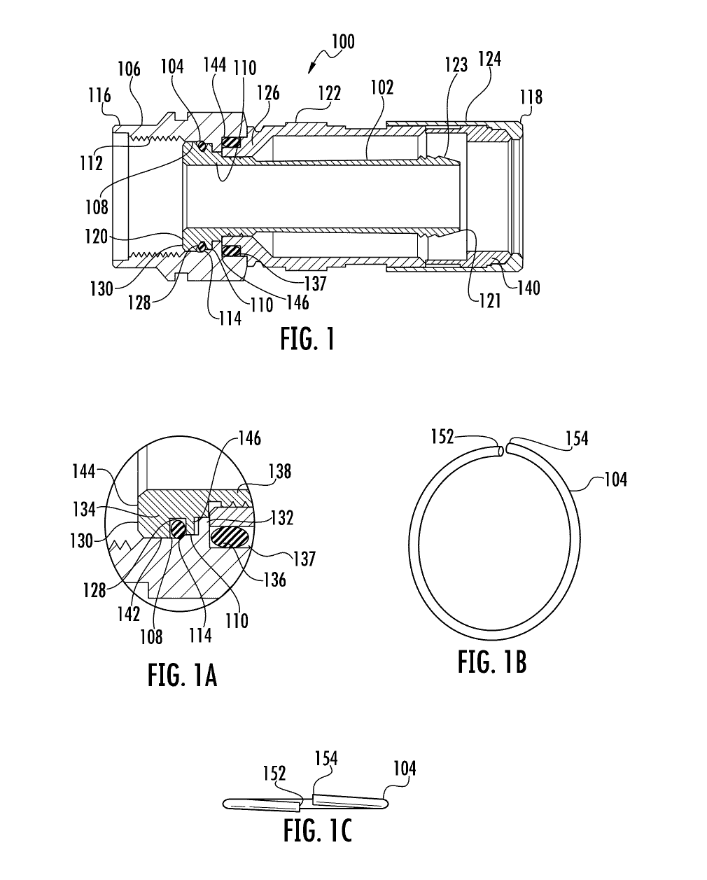

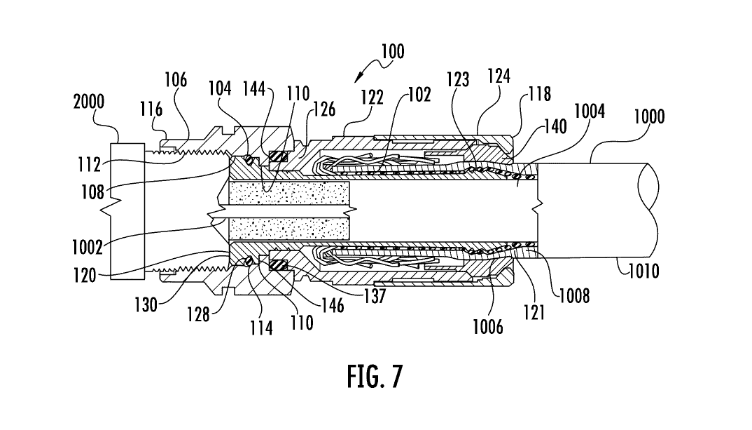

FIG. 1 illustrates a coaxial cable connector 100 having a post 102, a grounding member 104, a coupler 106, a front end 116 and a back end 118. Coupler 106 has a first bore 108. a second bore 110, a lip 132 with a forward facing surface 134 and a rearward facing surface 136. First bore 108 may have a threaded portion 112, and second bore 110 may have a tapered transition portion 114. Post 102 has first end 120, head 130, neck 138 and second end 121 with coupler 106 rotatably secured over end 120 of post 102 for attaching the connector 100 to an appliance (not shown). Barbs 123 located on post 102 proximate second end 121 facilitate attaching coaxial cable to connector 100 which is discussed in more detail with reference to FIG. 7. Head 130 has bottom surface 142, forward facing surface 144 and a rearward facing surface 146. Body 122 secures to post 102 and shell 124 movably secures to body 122 such that shell 124 may slide over body 122. Gripping member 140 friction fits in shell 124. O-ring 137 may be positioned between coupler 106 and body 122 to provide environmental protection for the coaxial cable connector 100. Body 122 may be made of brass, plated with nickel. Shell 124 also may be made of brass, plated with nickel. Post 102 may be metallic, for example, brass, with a tin plating. Coupler 106 may be metallic, for example, brass, and plated with nickel or with another non-corrosive material.

In FIG. 1, coupler 106 is shown rotatably secured over end 120 of post 102 via a neck 126 of the body 122. An electrical grounding path may be established and maintained between coupler 106 and post 102, including, in particular, when the coupler 106 is not tightly fastened to the terminal using grounding member 104, which is resilient and electrically-conductive. Grounding member 104 may be disposed between post 102 and coupler 106 in structural feature in post 102, which is described in more detail with reference to FIG. 1A.

In this regard, as shown in FIG. 1A, structural feature in post 102 is shown as annular groove 128 in bottom surface 142 of head 130 of post 102. Grounding member 104 is disposed about and retained by annular groove 128 in post 102 proximate tapered transition portion 114 and about head 130 of post 102. Grounding member 104 is resilient and biased toward coupler 106 such that grounding member 104 contacts both post 102 and tapered transition portion 114 of coupler 106. In this way, grounding member 104 establishes and maintains an electrically-conductive, stable ground path between coupler 106 and post 102, including, in particular, when the coupler 106 is not tightly fastened to the terminal.

Referring also now to FIGS. 1B and 1C, details of grounding member 104 are shown. Grounding member 104 is shown as a spring member, or circlip, which may be constructed of a wire-type material. The spring action of the grounding member 104 serves to form a ground path from coupler 106 to tubular post 102 while allowing coupler 106 to rotate. Grounding member 104 is resilient and may be generally arcuately shaped, having first end 152 and second end 154, and may extend around post 102 over an arc of at least 225 degrees. Further, grounding member 104 may extend for a full 360 degrees or more. Grounding member 104 may be in the form of a generally circular or generally non-circular broken ring, or C-shaped member, formed as by bending a strip of metal wire into an arc, or from a C-shaped metal clip. Additionally, grounding member 104 may be in the form of a partial helical shape such that first end 152 and second end 154 are offset. Grounding member 104 may be made of stainless steel wire having a wire diameter of between 0.010-inch and 0.020-inch, such as, about 0.016-inch. Grounding member 104 may be constructed of stainless steel, and, therefore, may not be plated for corrosion resistance.

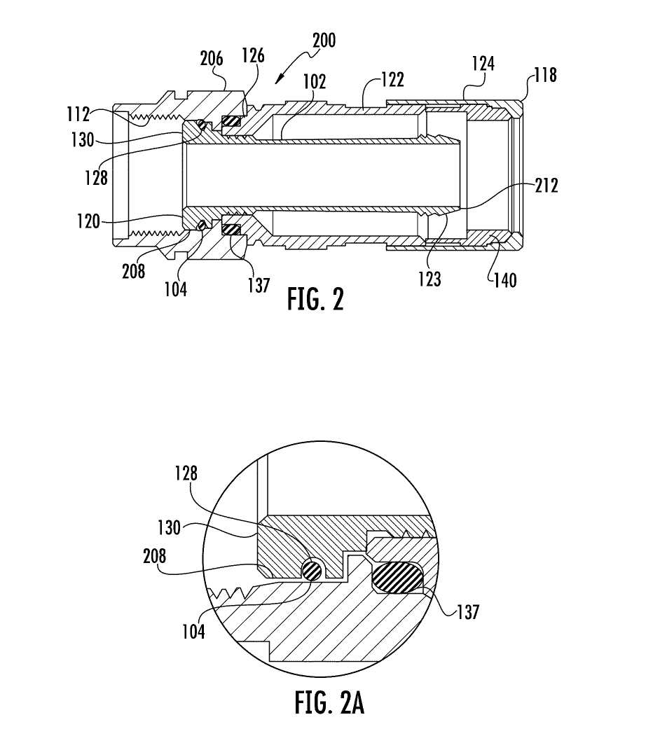

FIG. 2 illustrates a coaxial cable connector 200. Wherever possible, the same numbers for the same components as used for coaxial cable connector 100, will be used to describe coaxial cable connector 200. Additionally, components with the same or similar function as in coaxial cable connector 100 may not be described again with respect to coaxial cable connector 200. In at least one aspect, coaxial cable connector 200 differs from coaxial cable connector 100 in that coaxial cable connector 200 comprises coupler 206 not having a second bore 110 with a tapered transition portion 114. Instead, coupler 206 comprises straight bore 208. Coupler 206 is shown rotatably secured over end 120 of post 102 via a neck 126 of the body 122. The electrical grounding path may be established by grounding member 104, which is resilient and electrically-conductive. In this way, an electrical grounding path may be established and maintained between coupler 206 and post 102, including, in particular, when the coupler 206 is not tightly fastened to the terminal. Grounding member 104 may be disposed between post 102 and coupler 206 in structural feature in post 102, a detail of which is shown in FIG. 2A.

Referring now to FIG. 2A, similar to the embodiment illustrated in FIG. IA, structural feature in post 102 is an annular groove 128. Grounding member 104 is disposed about and retained by annular groove 128 in post 102 proximate straight bore 208 and about head 130 of the post 102, and may be a spring member, or circlip, as described with reference to FIGS. 1B and 1C. Grounding member 104 is resilient and biased toward coupler 206, such that grounding member 104 contacts both post 102 and coupler 206. In this way, grounding member 104 establishes and maintains an electrically-conductive, stable ground path between coupler 206 and post 102, including, in particular, when the coupler 206 is not tightly fastened to the terminal.

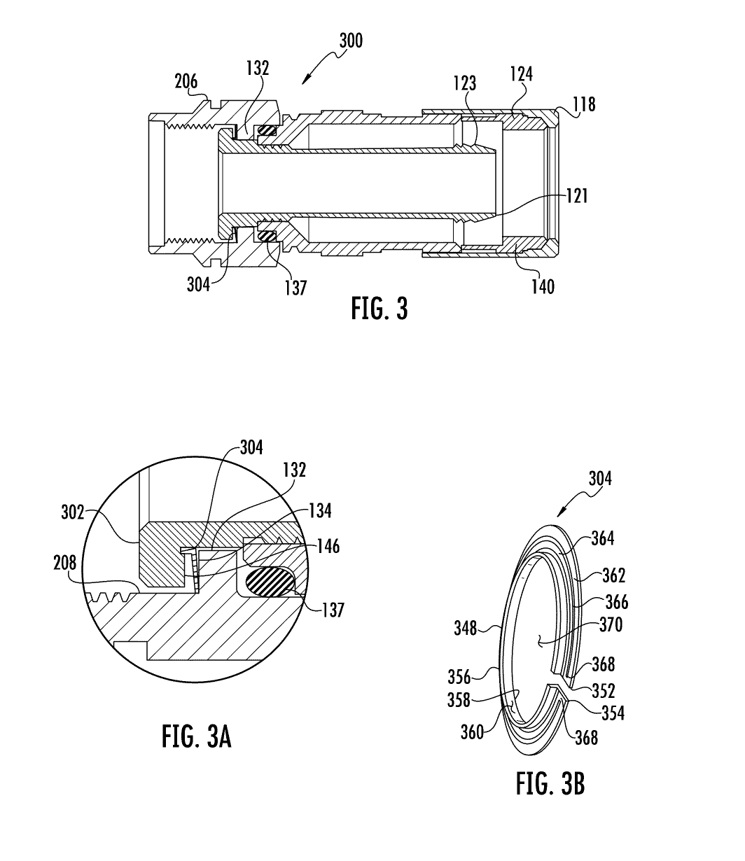

FIG. 3 illustrates coaxial cable connector 300. Wherever possible, the same numbers for the same components as used for coaxial cable connector 100, will be used to describe coaxial cable connector 300. Additionally, components with the same or similar function as in coaxial cable connector 100 may not be described again with respect to coaxial cable connector 300. Coaxial cable connector 300 includes coupler 206, post 302, and grounding member 304, with coupler 206 having straight bore 208. In at least one aspect, coaxial cable connector 300 differs from coaxial cable connector 100 in that rearward facing surface 146 of head 130 of post 302 has a structural feature such that grounding member 304 may be positioned between rearward facing surface 146 of head 130 and forward facing surface 134 of lip 132, which is described in more detail with reference to FIG. IA.

In this regard, as shown in FIG. 3A, the structural feature is a circumferential groove 328 in the rearward facing surface 146 of head 130 of post 302. Grounding member 304 has ring 348 which may position around and be press-fit to neck 138 of post 302. The ring 348 fits into and is retained by the circumferential groove 328 such that ring 348 may be “sandwiched” between the post 302 and the coupler 206 to provide a bearing surface between the coupler 206 and the post 302 when the coupler 206 is fully tightened against a terminal. Annular beam 350 extends from ring 348 and contacts forward facing surface 134 of lip 132 and may be a resilient, spring-like extension from ring 348. In this way, when coupler 206 is not fully tightened on a terminal, annular beam 350 of grounding member 304 maintains contact between post 302 and forward facing surface 134 of lip 132 of coupler 206.

Referring now to FIG. 3B, there is shown a perspective view of grounding member 304 having ring 348 and resilient, spring-type extension 350. Grounding member 304 is resilient and is generally arcuately shaped and may have first end 352 and second end 354. Grounding member 304 may extend over an arc of at least 225 degrees, and may extend for 360 degrees. Ring 348 may have first edge 356 and second edge 358 with width 360 between first edge 356 and second edge 360. Width 360 may be about 0.020 inches. Annular beam 350 may be pre-formed and cantilevered extending radially from ring 348. Additionally, grounding member 304 may have a plurality of pre-formed cantilevered annular beams 350. The annular beam 350 is flexible, resilient, arcuately shaped and extend at approximately a 10 degree angle from the plane of the ring 348. Annular beam 350 may have an outer surface 362, an inner surface 364 and a slot 366 therebetween. Joining segments 368 may join the outer surface 362 to the inner surface 364 and, thereby, to ring 348. The ring 348 defines a central aperture 370, which may be an open through space. Ring 348 may position about neck 138 of post 102 such that neck 138 fits into central aperture 370. At least one of the plurality of annular beams 350 contacts forward facing surface 134 of lip 132 of coupler 106. In this way, a ground path is may be established and maintained between post 102 and coupler 106. Grounding member 304 may be made from a metallic material, including as a non-limiting example, phosphor bronze. Additionally or alternatively, grounding member 304 may be un-plated or may be plated with a conductive material, as non-limiting examples, tin, tin-nickel or the like. Further, grounding member 104 may be constructed of stainless steel, and, therefore, may not be plated for corrosion resistance.

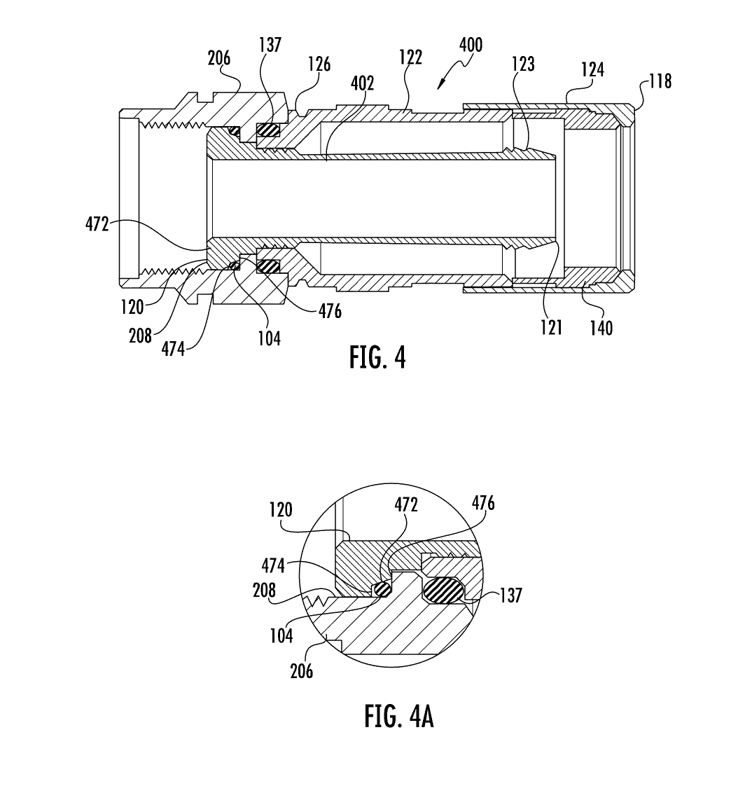

FIG. 4 illustrates coaxial cable connector 400. Wherever possible, the same numbers for the same components as used for coaxial cable connector 100, will be used to describe coaxial cable connector 400. Additionally, components with the same or similar function as in coaxial cable connector 100 may not be described again with respect to coaxial cable connector 400. In at least one aspect, coaxial cable connector 400 differs from coaxial cable connector 100 in that coaxial cable connector 400 comprises a post 402 having tapered portion 472 between a first radial face 474 and a second radial face 476, grounding member 104, and coupler 206. Additionally, coupler 206 comprises straight bore 208. Coupler 206 is shown rotatably secured over end 120 of post 402 via a neck 126 of the body 122. Grounding member 104 may be disposed between post 402 and coupler 206 in structural feature in post 402 formed by tapered portion 472 and first radial face 474, as described in more detail with reference to FIG. 4A. The electrical grounding path is established by grounding member 104, which is resilient and electrically-conductive. In this way, the electrical grounding path may be maintained between coupler 206 and post 402, including, in particular, when the coupler 206 is not tightly fastened to the terminal.

In this regard, as shown in FIG. 4A, grounding member 104 is disposed about tapered portion 472 and first radial face 474 proximate forward facing surface 134 of lip 132 and straight bore 208 of coupler 206, and is retained about the head 430 of the post 402 by tapered portion 472 and first radial face 474. In this way, grounding member 104 contacts both tapered portion 472, first radial face 474, forward facing surface 134 and straight bore 208 providing for an electrically-conductive path between post 402 and coupler 206 without restricting rotation of the coupler 206 relative to post 402. Grounding member 104 may be a spring member, or circlip, disposed between coupler 206 and post 402. The spring action of the grounding member 104 serves to establish a ground path from coupler 206 to the tubular post 402 while allowing coupler 206 to rotate and establishes and maintains a ground path between the coupler 206 and the post 402, as is described in more detail with reference to FIGS. 1B and 1C, above.

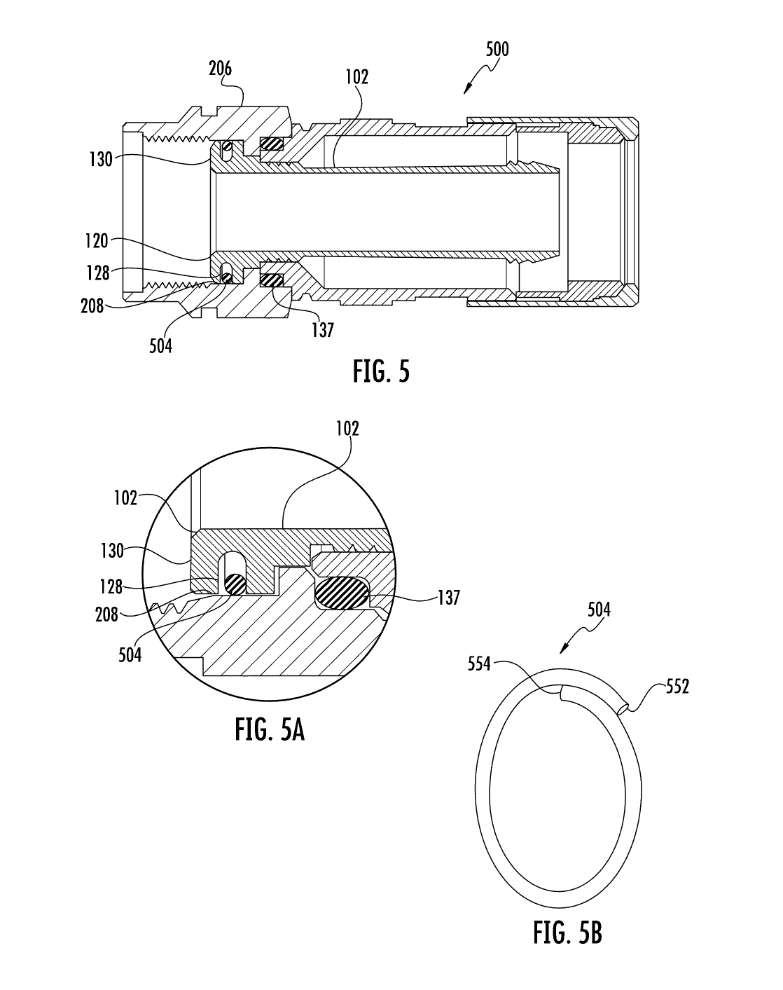

FIG. 5 illustrates coaxial cable connector 500. Wherever possible, the same numbers for the same components as used for coaxial cable connector 100, will be used to describe coaxial cable connector 500. Additionally, components with the same or similar function as in coaxial cable connector 100 may not be described again with respect to coaxial cable connector 500. In at least one aspect, coaxial cable connector 500 differs from coaxial cable connector 100 in that coaxial cable connector 500 comprises grounding member 504 having an overlapping structure (more than 360 degrees) with a circular cross-section. Additionally, coupler 206 comprises a straight bore 208. The electrical grounding path is provided by a resilient, electrically-conductive grounding member 504 disposed between post 102 and coupler 206 and without restricting rotation of coupler 206 relative to post 102.

Referring now to FIG. 5A, similar to the embodiment illustrated in FIG. IA, structural feature in post 102 is an annular groove 128. Grounding member 504 may be disposed about and retained by annular groove 128 in post 102 proximate straight bore 208 and about head 130 of the post 102. In this way, grounding member 504 may be retained about the head 130 of the post 102 by annular groove 128 in the post 102. Annular groove 128 in post 102 as shown in FIG. 5A is “deeper” than annular groove 128 shown in FIG. IA. This is to accommodate the overlapping structure of grounding member 504. In this manner, grounding member 504 may contact a larger portion of the vertical walls of annular groove 128 in post 102 as compared to the embodiment illustrated in FIG. IA. Grounding member 504 may be a spring member, or circlip, as described in more detail with reference to FIG. 5B and may be resilient and biased toward coupler 206, such that grounding member 504 contacts both post 102 and coupler 206 at straight bore 208. The spring action of the grounding member 504 serves to form a ground path from the coupler 206 to post 102 while allowing the coupler 206 to rotate. In this way, grounding member 504 establishes an electrically-conductive, stable ground path between coupler 206 and post 102 without restricting rotation of coupler 206 relative to post 102.

In this regard, as shown in FIG. 5B, grounding member 504 may be a spring member, or circlip, having an overlapping structure (more than 360 degrees) with a circular cross-section. Grounding member 504 may be resilient and is generally arcuately shaped extending over an arc of at least 360 degrees and may have first end 552 and second end 554. Grounding member 504 may be constructed of a wire-type material and arcuately shaped in the form of a generally circular or non-circular broken ring, by bending a strip of metal wire into an arc. Grounding member 504 may be made of stainless steel wire that has a wire diameter of between 0.010-inch and 0.020-inch, such as a diameter of about 0.016-inch. Stainless steel may be used and, therefore, grounding member 504 may not be plated for corrosion resistance.

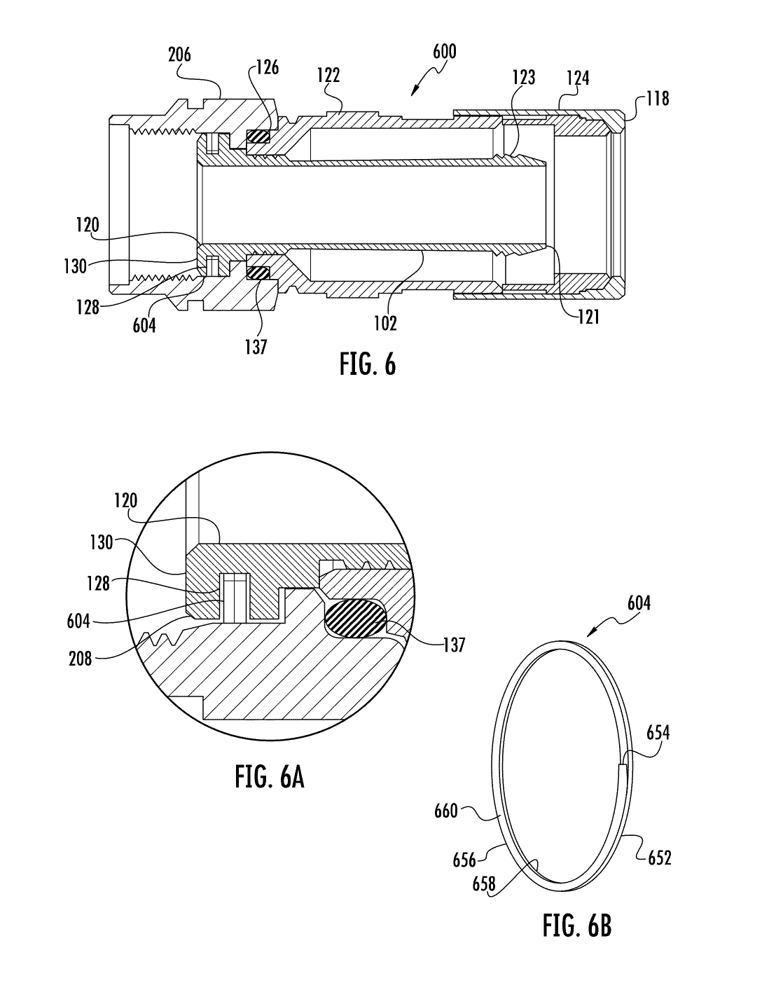

FIG. 6 illustrates coaxial cable connector 600. Wherever possible, the same numbers for the same components as used for coaxial cable connector 100, will be used to describe coaxial cable connector 600. Additionally, components with the same or similar function as in coaxial cable connector 100 may not be described again with respect to coaxial cable connector 600. In at least one aspect, coaxial cable connector 600 differs from coaxial cable connector 100 in that coaxial cable coaxial cable connector 600 comprises grounding member 604 having a flat generally circular structure. Additionally, coaxial cable connector 600 comprises coupler 206 having a straight bore 208. The electrical grounding path is provided by a resilient, electrically-conductive grounding member 604 disposed between post 102 and coupler 206.

Referring now to FIG. 6A, similar to the embodiment illustrated in FIG. IA, structural feature in post 102 is an annular groove 128. Grounding member 604 is disposed about and retained by annular groove 128 in post 102 proximate straight bore 208 and about head 130 of the post 102. Annular groove 128 in post 102 as shown in FIG. 6A may be deeper than annular groove 128 shown in FIG. 1A to accommodate the overlapping structure of grounding member 604. In this way, grounding member 604 may contact a larger portion of the vertical walls of annular groove 128 in post 102 as compared to the embodiment illustrated in FIG. IA. Grounding member 604 may be a flat, circular structure having a spring action, as described in more detail with reference to FIG. 6B and may be resilient and biased toward coupler 206, thereby contacting both post 102 and coupler 206 at straight bore 208. In this way, grounding member 604 may establish and maintain an electrically-conductive, stable ground path between coupler 206 and post 102, including, in particular, when the coupler 206 is not tightly fastened to the terminal and without restricting rotation of coupler 206 relative to post 102.

As shown in FIG. 6B, grounding member 604 has a flat, generally arcuate structure with first end 652 and second end 654, which may overlap. In other words, grounding member 604 may extend over an arc of at least 360 degrees or more. Grounding member 604 may have first edge 656, second edge 658 with width 660 therebetween. Width 660 may be about 0.035 inches. The arcuately shaped grounding member 604 may be in the form of a generally arcuate flat ring that may or may not be generally circular. Grounding member 604 may be made of stainless steel material that has a thickness of between 0.005-inch and 0.020-inch and, preferably, about 0.005-inch. Stainless steel may be used and grounding member 604 may not be plated for corrosion resistance.

FIG. 7 is a cross-sectional view of coaxial cable connector 100 having a prepared coaxial cable 1000 inserted therein and attached to terminal 2000. Coaxial cable 1000 has a center conductor 1002 that is surrounded by a dielectric layer 1004. Dielectric layer (or dielectric) 1004 may also have a foil or other metallic covering 1006. Coaxial cable 1000 has a braided outer conductor 1008 which is covered and protected by a jacket 1010. Typically, to prepare coaxial cable 100 for attachment to connector 100, a portion of the center conductor 1002 is exposed. Jacket 1010 is trimmed back so that a portion of dielectric 1004 (and metallic covering 1006) and braided outer conductor 1008 are exposed. Braided outer conductor 1008 is then folded back over jacket 1010 to expose dielectric 1004 (and the metallic covering 1006 if present).

Coaxial cable 1000 inserts through second end 118 of body 122. In this way, body 122 and post 102 receive the coaxial cable 1000. Post 102 at back end 121 is inserted between outer conductor 1008 and dielectric layer 1004. Shell 124 is advanced toward coupler 106 forcing gripping member 140 between body 122 and jacket 1010, securing coaxial cable 1000 in coaxial cable connector 100. Additionally, post 102, and particularly barbs 123, establish contact with outer conductor 1008 providing for mechanical and electrical continuity between outer conductor 1008 and post 102, and, thereby, coaxial cable connector 100. In this way, electrical continuity, and accordingly a ground path and RFI shield, may be established and maintained from outer conductor 1008 of coaxial cable 1000 through post 102, body 122, grounding member 104, and coupler 106 to terminal 2000. It should be understood, that although FIG. 7 illustrates coaxial cable connector 100 with coaxial cable 1000 inserted therein and attached to terminal 2000, all coaxial cable connectors as set out herein, and modifications thereof, may be substituted for coaxial cable connector 100 in the embodiment illustrated in FIG. 7.

Many modifications and other embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims.

It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A coaxial cable connector for coupling an end of a coaxial cable to an equipment appliance port or terminal, the coaxial cable comprising an inner conductor, a dielectric surrounding the inner conductor, an outer conductor surrounding the dielectric, and a jacket surrounding the outer conductor is disclosed, the coaxial cable connector comprising:
a body;
a coupler rotatably attached to the body;
a post secured to the body, wherein the post has a structural feature; and
a grounding member disposed in and retained by the structural feature, wherein the grounding member establishes an electrical grounding path between the post and the coupler.

2. The coaxial cable connector of claim 1, wherein the electrical grounding path is maintained between the post and the coupler when the coupler is not tightly fastened to a terminal.

3. The coaxial cable connector of claim 1, wherein the structural feature is a groove.

4. The coaxial cable connector of claim 3, wherein the post comprises a head and wherein the groove is an annular groove in a bottom surface of the head.

5. The coaxial cable connector of claim 3, wherein the post comprises a head, and wherein the groove is a circumferential groove in a rearward facing surface of the head.

6. The coaxial cable connector of claim 1, wherein the structural feature is formed by a tapered portion and a first radial face of the post.

7. The coaxial cable connector of claim 1, wherein the grounding member is resilient and biased toward coupler.

8. The coaxial cable connector of claim 1, wherein the grounding member has at least a partial helical structure.

9. The coaxial cable connector of claim 1, wherein the grounding member has an arcuate shape.

10. The coaxial cable connector of claim 9, wherein the grounding member is generally circular.

11. The coaxial cable connector of claim 9, wherein the grounding member is generally non-circular.

12. The coaxial cable connector of claim 9, wherein the grounding member has a flat generally circular structure.

13. The coaxial cable connector of claim 9, wherein the grounding member extends over an arc of at least 225 degrees.

14. The coaxial cable connector of claim 13, wherein the grounding member extends over an arc of at least 360 degrees.

15. The coaxial cable connector of claim 14, wherein the grounding member extends over an arc of more than 360 degrees.

16. The coaxial cable connector of claim 1, wherein the grounding member has a first end and a second end.

17. The coaxial cable connector of claim 1, wherein the grounding member comprises,
a ring, and
a cantilevered annular beam extending from the ring.

18. The coaxial cable connector of claim 17, wherein the ring has a central aperture.

19. The coaxial cable connector of claim 17, wherein the ring has a first edge and a second edge.

20. The coaxial cable connector of claim 19, wherein the ring has a width between the first edge and the second edge.

21. The coaxial cable connector of claim 17, wherein the cantilevered annular beam comprises a plurality of cantilevered annular beams.

22. A coaxial cable connector for coupling an end of a coaxial cable to an equipment appliance port or terminal, the coaxial cable comprising an inner conductor, a dielectric surrounding the inner conductor, an outer conductor surrounding the dielectric, and a jacket surrounding the outer conductor is disclosed, the coaxial cable connector comprising:
a body;
a coupler rotatably attached to the body, the coupler having a lip with a forward facing surface;
a post secured to the body, wherein the post comprises a first end, a head, a neck, and a second end, and wherein the post has a structural feature; and
a grounding member having an arcuate shape and disposed in and retained by the structural feature between the post and the coupler, wherein the grounding member is resilient and biased toward coupler, and wherein the grounding member establishes an electrical grounding path between the post and the coupler, and wherein the electrical grounding path is maintained between the post and the coupler when the coupler is not tightly fastened to a terminal.

23. The coaxial cable connector of claim 22, wherein the structural feature is a groove in the post.

24. The coaxial cable connector of claim 22, wherein the structural feature is formed by a tapered portion and a first radial face of the post.

25. The coaxial cable connector of claim 22, wherein the grounding member comprises,
a ring having a central aperture, and
a plurality of cantilevered annular beam extending from the ring.

26. The coaxial cable connector of claim 25, wherein the ring has a first edge, a second edge and a width between the first edge and the second edge.

27. The coaxial cable connector of claim 25, wherein the ring positions about the neck of the post such that the neck fits into the central aperture.

28. The coaxial cable connector of claim 25, wherein at least one of the plurality of cantilevered contacts the forward facing surface of the lip.
